(19) United States
(12) Patent Application Publication
(10) Pub. No.: US 2026/0340513 A1
(43) Pub. Date: Oct. 29, 2026

(54) DYNAMIC INFERENCING USING HYBRID MACHINE LEARNING MODELS

(71) Applicant: QUALCOMM Incorporated, San Diego, CA (US)

(72) Inventors: Amir JALALIRAD, Amsterdam (NL); Bence MAJOR, Amsterdam (NL); Arash BEHBOODI, Amsterdam (NL); Arvind Vardarajan SANTHANAM, San Diego, CA (US); Amr Mamoun MARTINI, San Diego, CA (US); Anantharaman BALASUBRAMANIAN, San Diego, CA (US)

(21) Appl. No.: 19/187,530

(22) Filed: Apr. 23, 2025

(51) Int. Cl. G06N 20/20

(52) U.S. Cl. CPC G06N 20/20

(57) ABSTRACT

Certain aspects of the present disclosure provide techniques and apparatus for generating a response to an input prompt using machine learning. An example method of machine learning by an edge device is provided. The method generally includes accessing an input prompt at the edge device. The method generally includes selecting, based on the input prompt and using a trained router machine learning model executing on the edge device, whether to process the input prompt using a first machine learning model or a second machine learning model. The second machine learning model has a larger size than the first machine learning model. The method generally includes, based on the selection, either: (i) generating a response to the input prompt using the first machine learning model executing on the edge device; or (ii) routing the input prompt to the second machine learning model for generation of the response.

### INTRODUCTION

Aspects of the present disclosure relate to machine learning and, more specifically, to hybrid generative artificial intelligence models executing on edge devices and potentially in a cloud environment.

Generative artificial intelligence models (also referred to herein as “generative machine learning models” or “generative models”) can be used in various environments in order to generate a response to an input prompt (e.g., a query). For example, generative artificial intelligence models can be used in chatbot applications in which large language models are used to generate an answer, or at least a response, to an input query. Other examples in which generative artificial intelligence models can be used include (i) stable diffusion, in which a model generates an image from an input text description of the content of the desired image, and (ii) decision transformers, in which future actions are predicted based on sequences of prior actions within a given environment.

Generally, generating a response to a prompt using generative artificial intelligence models may be computationally expensive. For example, in a chatbot deployment in which a large language model is used to generate a response to a query formatted as a text query, a response to the query may be generated using a pass through the large language model for each token (e.g., word or part of word) generated as part of the response. The output of each pass may be a probability distribution on a set of tokens (word(s) or portions of words) from which the next token may be selected, either by sampling or based on maximum likelihood. Because a pass through a large language model is used to generate each word (or token(s)) in a response to a query, the computational expense may be modeled as the product of the number of words included in the response and the computational resource expense (e.g., in terms of processing power, memory bandwidth, or other compute resources used) of performing a pass through the large language model, which generally increases as the number of parameters within the large language model increases.

### BRIEF SUMMARY

Certain aspects of the present disclosure provide a method of machine learning by an edge device. The method generally includes accessing an input prompt at the edge device. The method generally includes selecting, based on the input prompt and using a trained router machine learning model executing on the edge device, whether to process the input prompt using a first machine learning model or a second machine learning model. The second machine learning model has a larger size than the first machine learning model. The method generally includes, based on the selection, either: (i) generating a response to the input prompt using the first machine learning model executing on the edge device; or (ii) routing the input prompt to the second machine learning model for generation of the response.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example hybrid computing environment in which queries are dispatched for processing on different devices within the hybrid computing environment, according to aspects of the present disclosure.

FIG. 2 illustrates example input query offload in the example hybrid computing environment, according to aspects of the present disclosure.

FIG. 3 illustrates another example input query offload in the example hybrid computing environment, according to aspects of the present disclosure

FIG. 4 illustrates example training of a router machine learning model, according to aspects of the present disclosure.

FIG. 5A is an example graph depicting evaluation of performance of a router machine learning model and a random model selection, according to aspects of the present disclosure.

FIG. 5B is an example graph depicting evaluation of performance of multiple router machine learning models and a random model selection, according to aspects of the present disclosure.

FIG. 5C is an example graph depicting evaluation of multiple router machine learning models and a rule-based router, according to aspects of the present disclosure.

FIG. 5D is an example graph depicting evaluation of performance of multiple router machine learning models, according to aspects of the present disclosure.

FIG. 6 illustrates an example router machine learning model with an independent architecture, according to aspects of the present disclosure.

FIG. 7 illustrates an example router machine learning model branched out from the edge model, according to aspects of the present disclosure.

FIG. 8 illustrates example operations for machine learning by an edge device, according to aspects of the present disclosure.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for generating responses to input queries using generative machine learning models in a hybrid computing environment. The term “query” may be used interchangeably with the term “prompt” throughout the present disclosure.

Generally, machine learning models generate output in response to inputs. In some aspects, the machine learning models are generative machine learning models that generate a response to a query input into the model. As an example generative model, a large language model (LLM) can generate a response to a query using multiple passes through the large language model, with each successive pass being based on the query and the tokens (or words) generated using previous passes through the LLM. Generally, an LLM may include a large number (e.g., billions or trillions) of weights or parameters within the model. Because of the size of these models and the operations performed on each token to predict what should be the next token generated in response to a query and the previously generated tokens, it may not be practical, or even possible, to deploy LLMs on a variety of devices, such as (but not limited to) those that may have limited memory, storage, and/or processing capabilities relative to a cloud compute instance on which a LLM typically operates. Further, the memory bandwidth involved in generating a response to a query provided as input into a model may prevent compute resources from being used for other tasks. Further, LLMs use large computation power and consume more energy. In addition, because the LLMs may execute in the cloud, there may be a latency involved in sending queries to the cloud and receiving a response.

To allow for generative machine learning models to be used across different devices, differently sized generative machine learning models can be trained and may be deployed to different devices according to the compute capabilities of these devices. For example, a small language model (e.g., a compact model trained with between 7 billion and 20 billion tokens) may be deployed to edge devices, such as laptop computers, tablet computers, smartphones, or the like, while larger models (e.g., models trained with between 20 billion and 70 billion tokens, models trained with between 20 billion and 200 billion tokens, etc.) may be deployed to other devices (or second set or type of devices), such as server computers, a cloud compute instance, or other computing devices with more extensive compute capabilities. By using different-sized models, generative models can be used to generate responses to queries on a variety of devices. However, generally speaking, the size of a model may be related to the ability of the model to generate accurate responses to input queries. For example, more compact models may be able to generate accurate responses to a smaller range of queries than larger models, but as discussed, may be deployed on devices which may not be able to execute operations using these larger models due to a lack of available computing resources.

Aspects of the present disclosure provide techniques for a router machine learning model that dynamically routes query processing to different types or sizes of generative machine learning models in a hybrid computing environment. By routing query processing across different devices in a hybrid computing environment including edge devices and cloud computing environments, queries can be executed on specific devices based on the properties of the query and the capabilities of the models running on the devices.

According to certain aspects, a router machine learning model executing on an edge device dynamically routes queries to be processed by larger models (e.g., executing on one or more cloud devices) or smaller models (e.g., executing on the edge device). In some aspects, the router machine learning model is trained based on capabilities and performance of the machine learning model(s) on the edge device and on capabilities and performance of the machine learning model(s) on the cloud device(s). In some aspects, the router machine learning model is trained to classify the complexity of queries and to route queries based on the complexity. In some aspects, the router machine learning model is trained to predict response quality for the query of the machine learning models and to route the query based on the predicted response quality.

According to certain aspects, the router machine learning model executes separately and independently of the machine learning models on the edge device. According to other aspects, the router machine learning model executes as part of one or more machine learning models on the edge device.

Aspects of the present disclosure may ensure the accuracy of responses, while minimizing, or at least reducing, the amount of resources consumed and/or the latency in generating the responses.

While some aspects herein are discussed with respect to routing input queries to an edge machine learning model or to a cloud machine learning model, it should be understood that an edge device may be configured to run multiple different edge machine learning models and that a cloud device may be configured to run multiple different cloud machine learning models. Accordingly, a router machine learning model on an edge device may be trained to select among one or more edge machine learning models configured to run on the edge device, one or more edge machine learning models configured to run on another edge device, and one or more cloud machine learning models configured to run on one or more cloud devices for processing an input query.

Further, while some aspects herein are discussed with respect to edge machine learning models and cloud machine learning models, it should be understood that the techniques described herein may be used for routing an input query between any of multiple machine learning models, for example, between larger and smaller machine learning models on an edge device, a cloud device, or any another device.

According to certain aspects, the router machine learning model may be trained to learn the performance of all of the models and, for a given input query, the router machine learning model may be trained to select the smallest machine learning model with a specified acceptable performance level.

### Example Hybrid Machine Learning Models

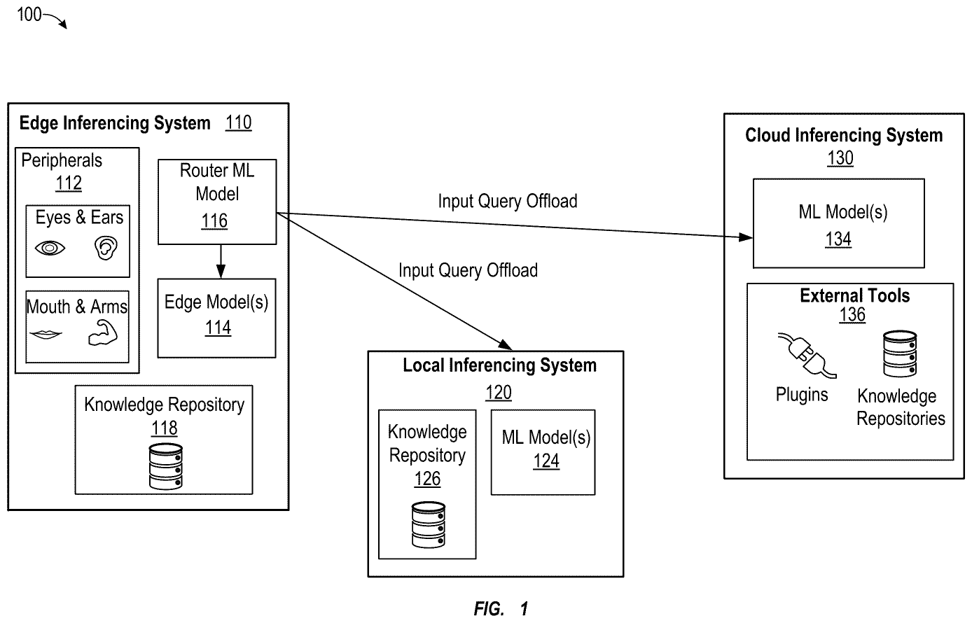

FIG. 1 illustrates an example hybrid computing environment 100 in which queries are dispatched for processing on different devices within the hybrid computing environment, according to aspects of the present disclosure.

As illustrated, the hybrid computing environment 100 includes an edge inferencing system 110, a local inferencing system 120, and a cloud inferencing system 130. The edge inferencing system 110 may correspond to a personal computing device on which a generative artificial intelligence model, such as a large language model (LLM) trained to generate textual responses to a textual query, is deployed. The local inferencing system 120 may correspond to a computing system that exposes a generative artificial intelligence model to a defined group of users, such as members of a family, members of a computing network, or some other defined group of users. Finally, the cloud inferencing system 130 may correspond to a generally available computing system, hosted in a cloud computing environment or other computing environment, that exposes a generative artificial intelligence model to the general public.

While FIG. 1 illustrates a hybrid computing environment including an edge inferencing system 110, a local inferencing system 120, and a cloud inferencing system 130, it should be recognized that the hybrid computing environment 100 may include any combination of any number thereof.

Generally, the edge inferencing system 110 may correspond to one or more devices having the most restricted computing capabilities (e.g., processing speed, memory capacity, memory bandwidth, etc.) within the hybrid computing environment 100. The local inferencing system 120 may generally correspond to one or more devices having more extensive computing capabilities than the edge inferencing system 110. The cloud inferencing system 130 may generally correspond to one or more devices having more extensive computing capabilities than the local inferencing system 120.

The edge inferencing system 110 may include one or more peripheral devices 112, one or more edge machine learning models 114, and a router machine learning model 116. The edge inferencing system 110 may include a knowledge repository 118 (also referred to as a “personal knowledge graph”). The one or more peripheral devices 112 may allow for the edge inferencing system 110 to ingest a query.

In some aspects, the one or more peripheral devices 112 may include a query detection model (not shown), which may execute continuously (e.g., as a background process, daemon, service, or the like), and can ingest data and other signals generated by the peripheral devices to determine when the ingested data is associated with a query. In some aspects, the edge inferencing system 110 may obtain text prompts input by a user via a user interface. In some aspects, the one or more peripheral devices 112 may execute continuously to identify, from spoken utterances captured by a microphone or other audio capture device connected with or integral to the edge inferencing system 110, the presence of specific key words indicative of a user presenting a query for processing. In this case, the edge inferencing system 110 may generate textual data and feature outputs from signals captured by the peripheral devices 112 that can be provided as an input into a machine learning model (e.g., the edge model(s) 114 deployed on the edge inferencing system 110, one or more machine learning models 134 deployed on the cloud inferencing system 130, and/or other machine learning models deployed on other devices within the hybrid computing environment 100).

As discussed in more detail herein, the router machine learning model 116 generally identifies which system in the hybrid computing environment 100 is to process the ingested query (or parts or a processed version thereof) and routes the ingested query to the identified system for processing. For example, the router machine learning model 116 can route (or cause routing of) an input query to the one or more edge models 114, the one or more machine learning models of the local inferencing system 120, and/or the one or more machine learning models 134 of the cloud inferencing system 130.

The local inferencing system 120, as illustrated, may receive requests to process input queries from the edge inferencing system 110. The local inferencing system 120 generally includes one or more machine learning models 124. The local inferencing system 120 may include a knowledge repository 126 that can be used to augment responses generated by the machine learning model 124. The knowledge repository 126 may be, for example, a knowledge graph or other knowledge repository that contains information relevant to a user or a specific group of users. The machine learning model(s) 124 deployed on the local inferencing system 120 may be larger model(s) than the edge model(s) 114 deployed on the edge inferencing system 110 and may thus be used to provide answers, for example, more quickly, with higher quality responses, and/or to more complex queries than those executed on the edge inferencing system 110.

The cloud inferencing system 130, as illustrated, may receive requests to process input queries from the edge inferencing system 110. The cloud inferencing system 130 generally includes one or more machine learning models 134. The cloud inferencing system 130 may include one or more external tools 136 (e.g., plugins, knowledge graphs (public and/or proprietary), etc.) that can be used to augment responses generated by the machine learning model(s) 134 on the cloud inferencing system 130.

Generally, the machine learning model(s) 134 deployed on the cloud inferencing system 130 may be larger than the edge model(s) 114 deployed on the edge inferencing system 110 and the machine learning model(s) 124 deployed on the local inferencing system 120. The machine learning model(s) 134 deployed on the cloud inferencing system 130 can be used to generate responses to queries offloaded from the edge inferencing system 110.

According to certain aspects, the router machine learning model 116 routes the queries based on a classification of the queries. In some aspects, the router machine learning model 116 classifies input queries by complexity.

Aspects of the present disclosure provide an example of query complexity based on application programming interface (API) calls involved in generating a response to the query. It should be understood, however, that input queries can be classified by complexity based on other parameters, such as programming queries, tabular data queries, context length and dependency, knowledge depth and specialization, reasoning and multi-step processing, creativity and open-endedness, multi-modal and cross-domain processing, and/or personalization and memory use.

Regarding context length and dependency, a simple query may be one that is short and self-contained, involving minimal context (e.g., “Define photosynthesis.”). On the other hand, a more complex query may be longer and rely on long-term dependencies or context retention (e.g., “Summarize this 10-paragraph article and compare it to another article I provided earlier.”)

Regarding knowledge depth and specialization, a simple query may generate knowledge questions that any model can answer well (e.g., “Who was the first president of the U.S. ?”). On the other hand, a more complex query may be a highly specialized question calling for domain expertise (e.g., “Explain the impact of quantum entanglement on cryptographic security models.”).

Regarding creativity and open-endedness, a simple query may be a closed-ended or structured prompt (e.g., “Write a haiku about the ocean.”). On the other hand, a more complex query may be open-ended, abstract, or multi-constraint creative tasks (e.g., “write a short story where a time traveler accidently changes the outcome of World War II, but in a way that makes no one notice.”).

Regarding reasoning and multi-step processing, a simple query may be a straightforward factual query (e.g., “What is the capital of France?”). On the other hand, a more complex query may call for multi-step reasoning, logic-based tasks, or problem-solving (e.g., “Find the next number in this sequence and explain the pattern: 2, 6, 12, 20, . . . ”).

Regarding multi-modal and cross-domain processing, a simple query may call for single-domain text-based tasks (e.g., “Summarize this text.”). On the other hand, a more complex query may demand multi-mode (e.g., text, image, audio, and/or video) or cross-domain tasks (e.g., “Analyze this image and generate a poem based on its contents.”).

Regarding personalization and memory use, a simple query may call for general responses without involving personalization (e.g., “What are good exercises for beginners?”). On the other hand, a more complex query may call for personalized responses relying on historical context (e.g., “Based on my previous messages, suggest an exercise routine tailored to my current fitness level.”).

In some aspects, a simple query may be one that calls for encoded knowledge available in training data (e.g., “What was Einstein's first name?”), whereas a more complex query may lead to API calls (e.g., “Can you book a table for 6 in a Greek restaurant for tonight?”).

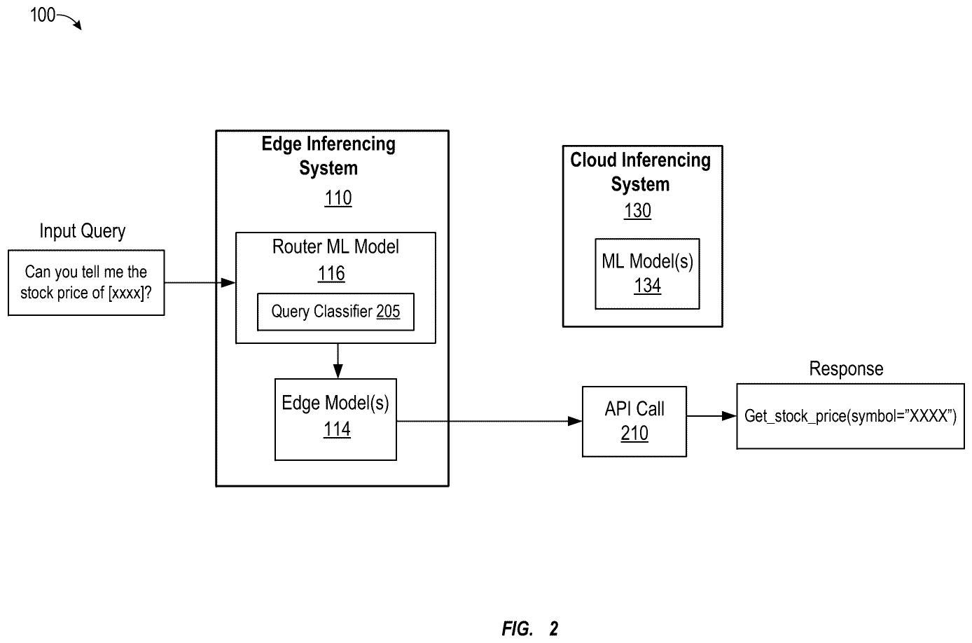

FIG. 2 illustrates example input query offload in the example hybrid computing environment 100, according to aspects of the present disclosure. As shown, the edge inferencing system 110 may obtain an input query (e.g., “Can you tell me stock price of [xxxx]?”). The router machine learning model 116 may classify the query, with a query classifier 205. In the illustrated example, the input query may be classified as a simple query that can be processed by the edge model(s) 114 of the edge inferencing system 110. In this example, the router machine learning model 116 routed the query to the edge model(s) 114 on the edge inferencing system 110. In the illustrated example, a selected edge model 114 generates an application programming interface (API) call 210 to a function. For example, the selected model generates the API call “get_stock_price(symbol=‘XXXX’)” which returns the requested stock price.

In some aspects, a complex query may involve multiple APIs, digesting outputs of the API calls, and potentially further API calls based on those outputs in order to generate a query response. In some aspects, a machine learning model may have a list of available functions relying on one or more correct arguments for an API call to generate a query response. In some aspects, query complexity may be classified based on the number of functions and arguments involved for generating a response. For example, in increasing order of complexity, a query may be classified based on generating a response involving: (i) calling a single provided function with correct arguments once; (ii) calling the single provided function with correct arguments multiple times; (iii) calling a correction function with correct arguments once; (iv) calling the correct function with correct arguments multiple times; and (v) calling the correction function with correct arguments and using the output for calling another function.

As an example of calling a single provided function with correct arguments once, a function “getWeather” may be specified with a single argument “location.” As an example of calling the single provided function with correct arguments multiple times, the function “getWeather” may called for “location”=[“New York”, “London”, “Tokyo”]. Accordingly, the model makes multiple calls to the same function for different locations. As an example of calling a correction function with correct arguments once, the model may call different functions “getWeather” location “Paris” to fetch current weather report for Paris or the function “getForecast” location “Paris” to fetch the weather forecast for Paris. As an example of calling the correct function with correct arguments multiple times, the functions “getWeather” or “getForecast” may be called for multiple different locations [“Paris”, “Berlin”, “Rome”]. As an example of calling the correction function with correct arguments and using the output for calling another function, the model may call the function “getWeather” location “Paris” and receive an output “Temperature=22 degrees C.” The model may then call the function “getOutfitRecommendations” temperature “22 degrees C.” Thus, the model uses the output of the first function as the input parameter for the second function to receive the output recommendation response.

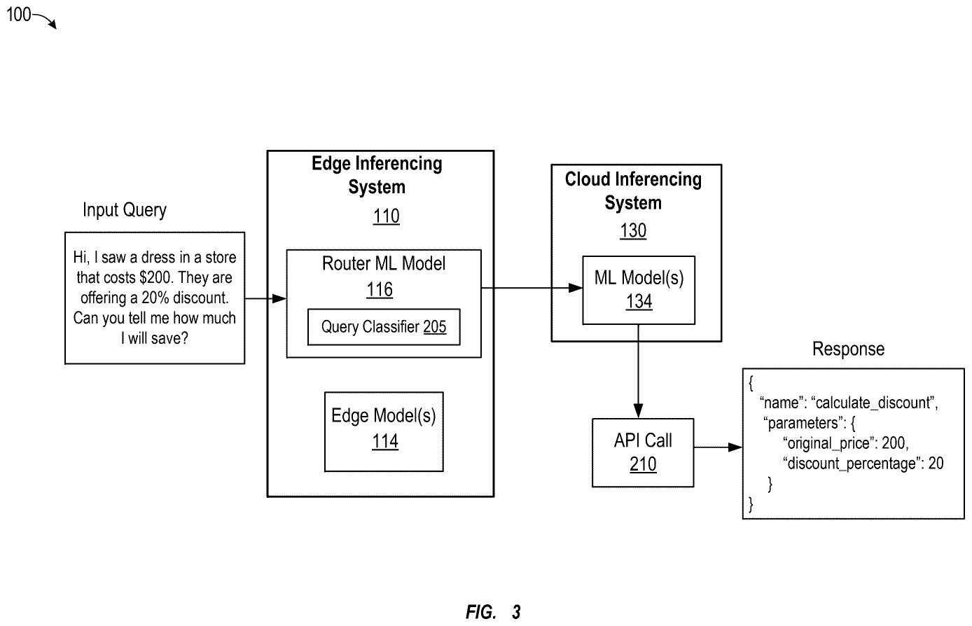

FIG. 3 illustrates example another input query offload in the example hybrid computing environment 100, according to aspects of the present disclosure. As shown, the edge inferencing system 110 may obtain an input query (e.g., “Hi, I saw a dress in a store that costs $200. They are offering a 20% discount. Can you tell me how much I will save?”). The router machine learning model 116 may classify the query, with the query classifier 205. In the example, the list of available functions and associated arguments may include:
{“name”: “calculate_discount”, “description”: “Calculate the discount amount based on original price and discount percentage”, “parameters”: {“type”: “object”, “properties”: {“original_price”: {“type”: “number”, “description”: “The original price of the item”}, “discount_percentage”: {“type”: “number”, “description”: “The discount percentage to be applied”}}, “required”: [“original_price”, “discount_percentage”]}};
{“name”: “get_news”, “description”: “Get the latest news based on category”, “parameters”: {“type”: “object”, “properties”: {“category”: {“type”: “string”, “description”: “The category of news”}, “country”: {“type”: “string”, “description”: “The country of news source”}}, “required”: [“category”, “country”]}}; or
{“name”: “send_email”, “description”: “Send an email”, “parameters”: {“type”: “object”, “properties”: {“recipient”: {“type”: “string”, “description”: “The recipient's email address”}, “subject”: {“type”: “string”, “description”: “The subject of the email”}, “message”: {“type”: “string”, “description”: “The content of the email”}}, “required”: [“recipient”, “subject”, “message”]}}.

In the illustrated example, generating a response to the input query may involve calling the correction function “calculate_discount” with the correct arguments “original_price” of $200 and “discount_percentage” of 20. In the illustrated example, the input query may be classified as a complex query that can be processed by the machine learning model(s) 134 of the cloud inferencing system 130. In this example, the router machine learning model 116 routed the query to the cloud machine learning model(s) 134 on the cloud inferencing system 130. In the illustrated example, a selected cloud machine learning model 134 generates an API call 210 to a function. For example, the selected cloud machine learning model 134 generates the API call 210 “get_stock_price(symbol=‘XXXX’)” which returns the requested stock price.

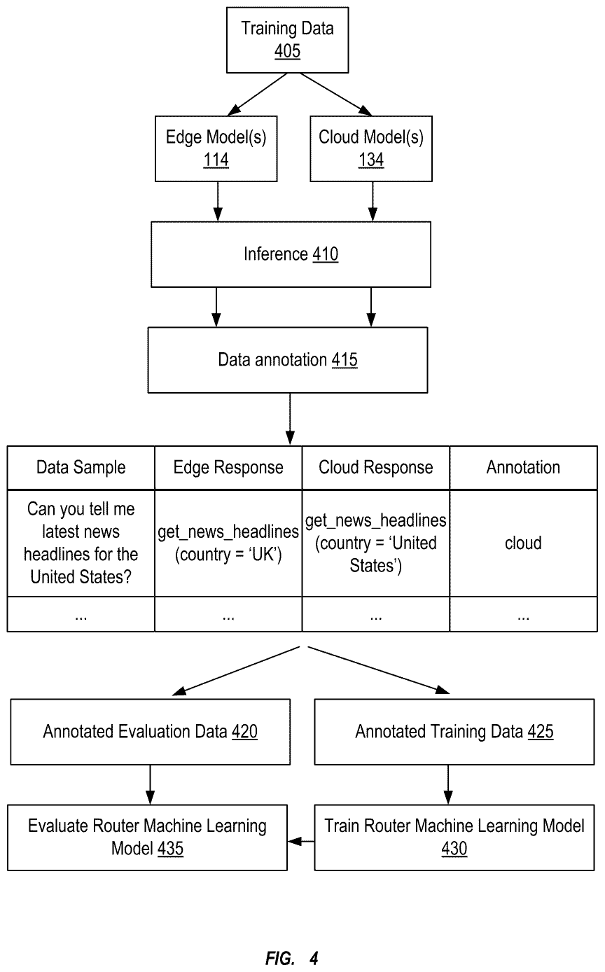

FIG. 4 illustrates example training of the router machine learning model 116, according to aspects of the present disclosure.

As shown, a training dataset 405 is input to both the edge model(s) 114 and the cloud machine learning model(s) 134.

The edge model(s) 114 and the machine learning model(s) 134 each run inferencing on the training dataset 405 at block 410.

At block 415, the training dataset is annotated based on the results of the inferencing. In some aspects, the annotating may be performed automatically.

As shown in FIG. 4, for a data sample (input query), “Can you tell me latest news headlines for the United States?”, the inferencing result (at block 410), by the edge model 114 results in the correct function, “get_news_headlines” being called, but with the incorrect argument “UK” instead of “United States.” As shown, the inferencing result by the cloud machine learning model 134 results in both the correct function and the correct argument.

Accordingly, the data sample is annotated as the “cloud.” In some aspects, if both models provided the correct response, the data sample may be marked “edge” to indicate that the smaller model should be used. In some aspects, if both models provided the correct response, the data sample may be marked with both “edge” and “cloud” to indicate that both models provided the correct response. For example, in the case that both the edge and cloud models are predicted to provide an incorrect response, the router machine learning model 116 may route the input query to the smaller edge model.

While the illustrated example only depicts annotating the data with the model providing the correct, or better, response, it should be understood that data may be annotated in other ways. For example, the data may be annotated with various different metrics and combinations of metrics indicating various parameters of the response quality.

As shown in FIG. 4, the annotated data is split into annotated evaluation data 420 and annotated training data 425. At block 430, the annotated training data 425 may be used to train the router machine learning model 116 to learn the response quality of the edge model(s) 114 and the cloud machine learning model(s) 134 given different input queries.

At block 435, the annotated evaluation data 420 may be used to evaluate how well the trained router machine learning model 116 can predict the performance of the models given a query.

According to certain aspects, the router has a classifier head which outputs a predicted confidence level of the performance of a machine learning model to respond correctly to the input query.

In some aspects, the classifier head aggregates information in the input query using a pooling mechanism. For example, the classifier head may use a max pooling mechanism in which the classifier head takes the maximum value along each feature dimension across all tokens to capture the most dominant features in the sequence of tokens. As another example, the classifier head may use an average pooling mechanism in which the classifier head computes the mean of all tokens and provides a smooth representation of the sequence. As yet another example, the classifier head may use a linear layer pooling mechanism in which the classifier head applies a learned weight matrix to each token and combines the weighted tokens into a single vector. As yet another example, the classifier head may use a last token index mechanism, in which the classifier head uses only the final token.

In some aspects, the classifier head determines the confidence level for the edge model(s) 114 and compares the confidence level to a threshold. If the predicted confidence level is below a threshold, the router machine learning model 116 may route the input query to the machine learning model(s) 134 of the cloud inferencing system 130. If the predicted confidence level is at or above the threshold, the router machine learning model 116 may route the input query to the edge model(s) 114 of the edge inferencing system 110.

In some aspects, the threshold may be a threshold confidence level. In some aspects, the threshold is a confidence differential, for example, between a confidence level for the edge model and a confidence level for the cloud machine learning model. In this case, if the confidence differential is below the threshold, the router machine learning model 116 may route the input query to the edge model(s) 114 of the edge inferencing system 110 (e.g., because the cloud machine learning model(s) 134 do not provide significantly higher confidence); and if the predicted confidence level is at or above the threshold, the router machine learning model 116 may route the input query to the cloud machine learning model(s) 134 of the cloud inferencing system 130.

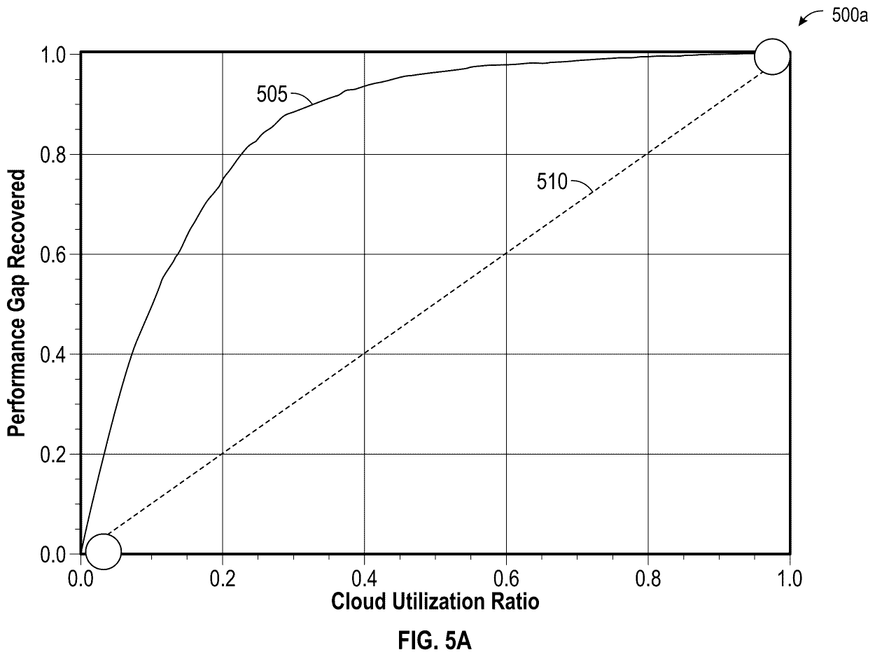

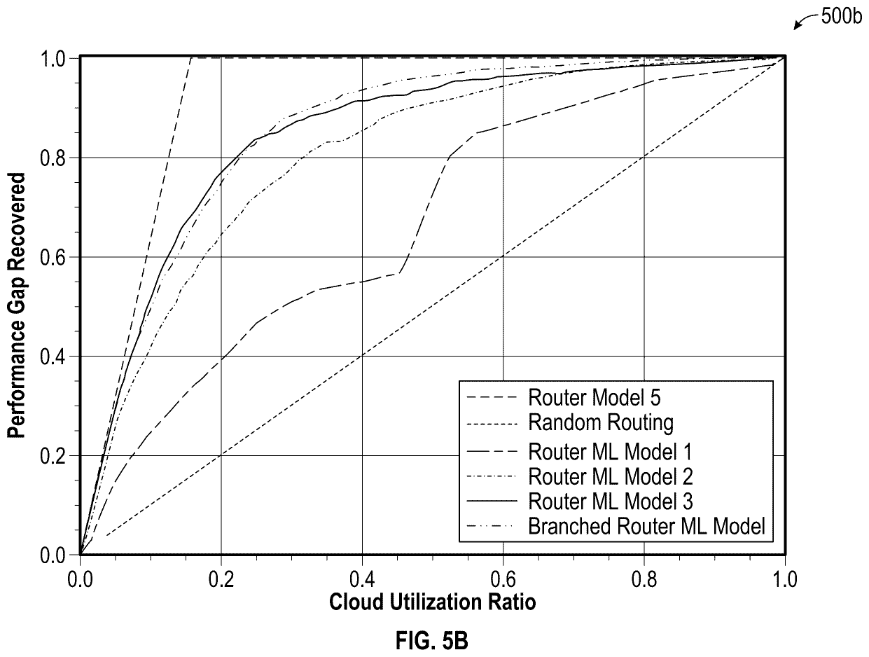

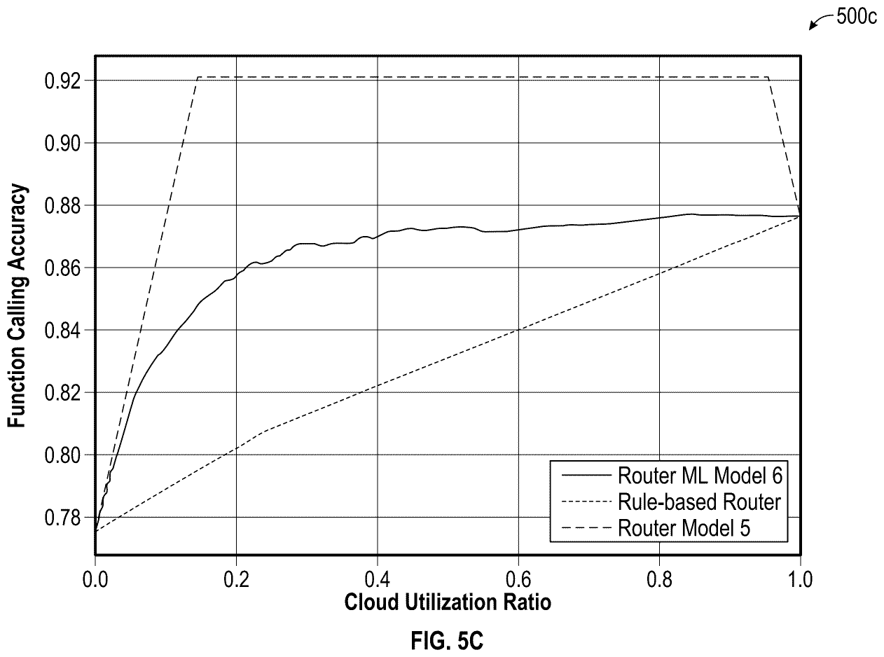

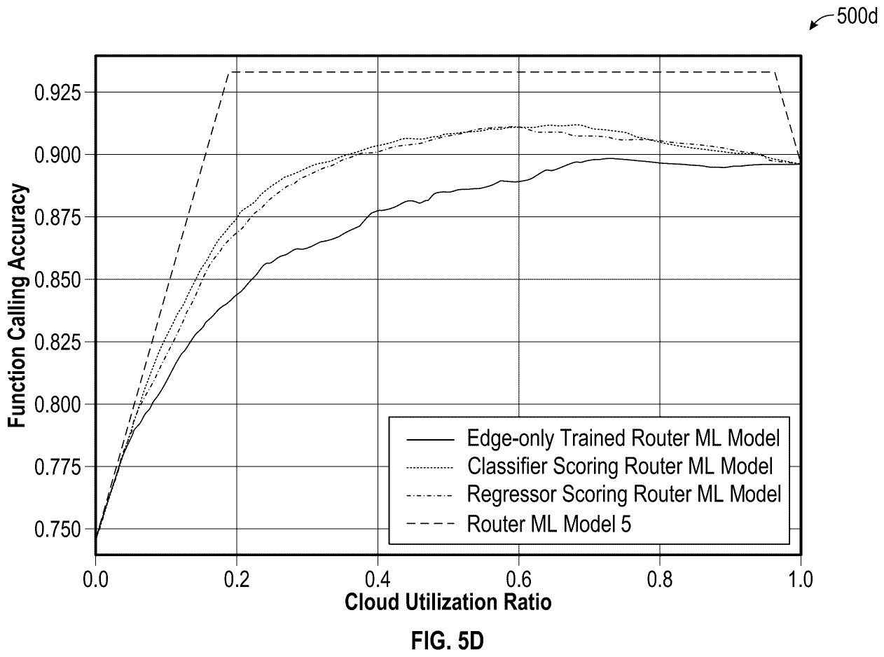

FIG. 5A is an example graph 500a depicting evaluation of performance of a router machine learning model and random model selection approach, according to aspects of the present disclosure. The curve 505 illustrates, for the router machine learning model 116, the performance gap recovered (on the y-axis) depending on the utilization ratio (on the x-axis) of a cloud machine learning model over the evaluation data 420 set. The curve 510 illustrates the performance gap for a random selection of the edge and cloud models for the input query processing. As shown, the router machine learning model 116 performs better than the random model selection.

In the illustrated example, when the edge model is always used (i.e., the utilization of the cloud machine learning model is 0.0), the performance is normalized as the worst performance (0.0). On the other hand, as shown, when the cloud machine learning model is always used (i.e., the utilization of the cloud machine learning model is 1.0), the performance is normalized as the best performance (1.0).

As shown by the curve 510, for a random selection of the edge model or cloud model for processing the input queries of the evaluation dataset, the performance improves linearly with the cloud model utilization ratio.

As shown by the curve 505, for the router machine learning model 116, the performance rises rapidly as the utilization of the cloud machine learning model increases to around 25-30% utilization (e.g., where the performance is around 85%), after which the performance gain drops off. Accordingly, the utilization of the cloud machine learning model can be set based on desired tradeoffs between the performance and the resource efficiency.

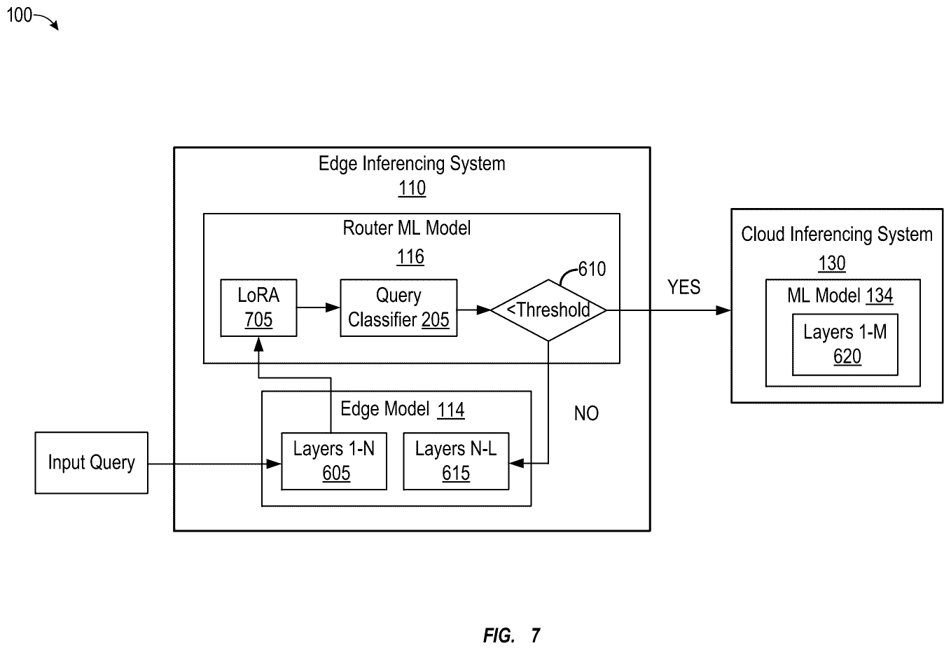

FIG. 5B is an example graph 500b depicting evaluation of performance of multiple machine learning models, according to aspects of the present disclosure. In FIG. 5B, machine learning model 5 (router model 5) an upper bound performing routing model; the “random” line represents the performance based on the random selection of the edge or cloud model; the router machine learning models 1-3 (router ML model 1, router ML model 2, router ML model 3) represent router machine learning models trained on increasing order of size; and the branched router machine learning model represents a router machine learning model branched from the edge model as described with respect to FIG. 7 below. In the illustrated example in FIG. 5B, the data is annotated only with whether the edge model responds to the query correctly or not, and it is assumed that the cloud model always responds to the query correctly.

As shown, as the router machine learning model size increases, the performance curve also improves, but at the cost of more compute and memory due to the larger model size. For example, router ML model 1 has the worst performance, followed by the router ML model 2, and the router ML model 3 has better performance than the router ML 1 and the router ML model 2. Because the branched router ML model saves on compute and memory shared with the edge model, a larger model can be used for the branch router ML model providing good performance as shown in FIG. 5B.

FIG. 5C is an example graph 500c depicting evaluation of multiple router machine learning models and a rule based router, according to aspects of the present disclosure. The graph 500c shows the accuracy of responses given to queries (y-axis) depending on the cloud model utilization (x-axis). In the example illustrated in FIG. 5C, the data set is annotated with whether the edge model responds to the input query correctly or not. In the example illustrated in FIG. 5C, the cloud machine learning does not answer all queries correctly. In the example illustrated in FIG. 5C, the rule-based router routes input queries to the cloud machine learning model if the input query is of the complexity type involving multiple API functions and to the edge model if the input query is of the complexity type involving a single API function. As shown in graph 500c, the router machine learning model 116 significantly outperforms the rule-based router, particularly, at lower cloud model utilization ratios.

FIG. 5D is an example graph 500d depicting evaluation of performance of multiple router machine learning models, according to aspects of the present disclosure. In the example illustrated in FIG. 5D, the data set is annotated with both whether the edge model responds to the input query correctly and with whether the cloud model responds to the input query correctly. In the example illustrated in FIG. 5D, the cloud machine learning does not answer all queries correctly. In the example illustrated in FIG. 5D, the edge-only trained router ML model represents a router machine learning model 116 trained only on data annotated with the successes and failures of the edge model to respond correctly to queries, whereas the classifier scoring router ML model and the regressor scoring router ML model are trained with the data annotated with the successes and failures of both the edge model and the cloud machine learning model to respond correctly to queries. The classifier scoring router ML model represents a model that classify queries into four classes: both models fail; edge model fails, cloud model succeeds, edge model succeeds, cloud model fails, and both models succeed. The regressor scoring router ML model represents a model that outputs a score for edge failure.

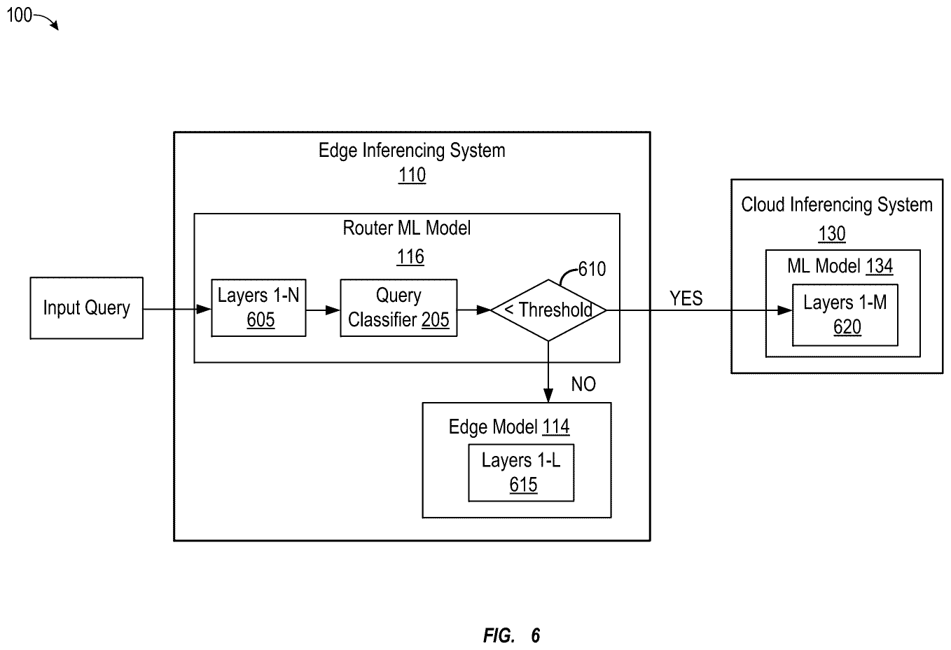

FIG. 6 illustrates an example router machine learning model 116 with an independent architecture, in which the router machine learning model 116 is separate and independent of the edge model(s) 114, according one or more aspects. As shown, an input query may be processed at the router machine learning model 116 by one or more layers 1-N 605. In natural language processing machine learning models, the first operations include converting natural language words into numbers to enable mathematical operations. This process is called tokenizing the input prompt. Next, the model may include N layers of math operations, where relevant information is extracted and encoded sequentially. The extracted and encoded information may be used by the query classifier 205 to predict a confidence level for the edge model(s) 114 and/or for the cloud inferencing system 130. In some aspects, if the confidence level is above the threshold at decision block 610, then the router machine learning model 116 routes the input query to the edge model 114 where layers 1-L 615 of the edge model 114 are used to generate a query response. In some aspects, if the confidence level is at or below the threshold at the decision block 610, then the router machine learning model 116 routes the input query to the machine learning model 134 on the cloud inferencing system 130, where layers 1-M 620 of the machine learning model 134 are used to generate a query response.

FIG. 7 illustrates an example router machine learning model 116 branched out from the edge model 114, according to aspects of the present disclosure. In this example, the tokenizing operation and one or more first layers of information extraction and encoding are common between the edge model 114 and the router machine learning model 116. Thus, starting from a common extracted encoding (e.g., after layers 1-N 605), the branch corresponding to the rest of the router machine learning model 116 can produce a single number for comparison to the threshold, and the remaining layers N-L 615 of the edge model 114 can produce encodings that are decodable to natural language. As shown in FIG. 7, the input query may first be processed by the layers 1-N 605 of the edge model 114 before processing at the router machine learning model 116. In some aspects, low rank adaptation 705 may be used on top of the layers 1-N 605. After comparing the confidence level to the threshold at the decision block 610, if the confidence level is at or above the threshold, then the router machine learning model 116 routes the input query to the edge model 114 where layers N-L 615 of the edge model 114 are used to generate a query response. Accordingly, the branched-out router machine learning model 116 saves on computation overhead.

### Example Operations for Machine Learning by an Edge Device

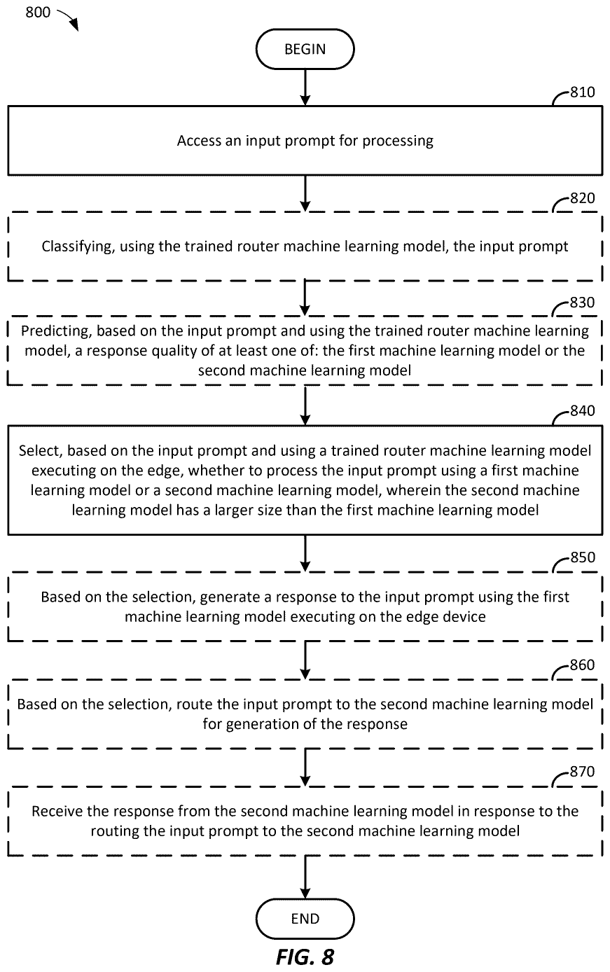

FIG. 8 illustrates example operations 800 for machine learning by an edge device, according to aspects of the present disclosure. The edge device may be a mobile device, such as a smartphone, laptop, tablet, wearable device, and the like. It should be understood that the operations 800 may be performed in conjunction with the various aspects discussed above with respect to FIGS. 1 through 7.

In some aspects, a trained router machine learning model is trained based on input prompt response quality and input prompt response processing cost capabilities of the first machine learning model and the second machine learning model. In some aspects, the trained router machine learning model is a routing neural network model.

As illustrated, the operations 800 begin at block 810, with accessing an input prompt at the edge device. In some aspects, the input prompt is input by a user via a user interface of the edge device.

Optionally, at block 820, the operations 800 may proceed with classifying, using the trained router machine learning model, the input prompt. In some aspects, the classifying, at block 820, includes classifying, using the trained router machine learning model, the input prompt to a prompt complexity level. In some aspects, the prompt complexity level is classified from a plurality of prompt complexity levels including at least one of: a first prompt complexity level involving one call to a single function or application programming interface (API) with correct arguments to respond to the input prompt; a second prompt complexity level involving multiple calls to the single function or API with the correct arguments to respond to the input prompt; a third prompt complexity level involving a single call to a correct function or API with the correct arguments to respond to the input prompt; a fourth prompt complexity level involving multiple calls to the correct function or API with the correct arguments to respond to the input prompt; or a fifth prompt complexity level involving: calling a first function or API with the correct arguments; and using the output of the first function or API to call a second function or to respond to the input prompt.

Optionally, at block 830, the operations 800 proceed with predicting, based on the input prompt and using the trained router machine learning model, a response quality of at least one of: the first machine learning model or the second machine learning model

At block 840, the operations 800 proceed with selecting, based on the input prompt and using a trained router machine learning model executing on the edge device, whether to process the input prompt using a first machine learning model or a second machine learning model. The second machine learning model has a larger size than the first machine learning model. In some aspects, the first machine learning model is a small language model (SLM), and the second machine learning model is a large language model (LLM). In some aspects, the first machine learning model is an edge machine learning model, and the second machine learning model is a cloud machine learning model configured to execute on a device external to the edge device.

In some aspects, the selecting, based on the input prompt and using the trained router machine learning model executing on the edge device, at block 840, is further based on the classification of the input prompt at block 820. In some aspects, the selecting, based on the input prompt and using the trained router machine learning model executing on the edge device, at block 840, includes selecting the first machine learning model when the prompt complexity level is at or above threshold. In some aspects, the selecting, based on the input prompt and using the trained router machine learning model executing on the edge device, at block 840, includes selecting the second machine learning model when the prompt complexity level is below the threshold.

In some aspects, the selecting, based on the input prompt and using the trained router machine learning model executing on the edge device, at block 840, includes selecting a smallest size machine learning model, of a plurality of machine learning models including the first machine learning model and the second machine learning model, having a predicted response quality satisfying a threshold. In some aspects, the threshold comprises a response quality threshold or a response quality difference threshold.

In some aspects, the trained router machine learning model is independent of the first machine learning model executing on the edge device. In some aspects, the trained router machine learning model is configured to: obtain a sequence of tokens corresponding to the input prompt; apply a pooling mechanism to the sequence of tokens to generate a pooling representation; output a confidence score based on the pooling representation; and compare the confidence score to a threshold. In some aspects, the selecting, based on the input prompt and using the trained router machine learning model executing on the edge device, at block 840, is further based on the comparison of the confidence score to the threshold. In some aspects, the pooling mechanism includes at least one of: maximum pooling, average pooling, linear layer pooling, or last token pooling.

In some aspects, the trained router machine learning model is integrated with the first machine learning model. In some aspects, the operations 800 include processing the input prompt by a first one or more layers of the first machine learning model executing on the edge device; and inputting the processed input prompt to the trained router machine learning model.

The operations 800 proceed with, based on the selection, either: at block 850 (i) generating a response to the input prompt using the first machine learning model executing on the edge device or, at block 860, (ii) routing the input prompt to the second machine learning model for generation of the response. In some aspects, generating the response to the input prompt using the first machine learning model executing on the edge device, at block 850, includes generating the response to the input prompt using a second one or more layers of the first machine learning model executing on the edge device. In some aspects, the operations 800 further include applying low rank adaptation, in the trained router machine learning model, to the processed input prompt from the first machine learning model executing on the edge device.

Optionally, at block 870, the operations 800 proceed with receiving the response from the second machine learning model in response to the routing the input prompt to the second machine learning model at block 860.

### Example Processing Systems for Machine Learning by an Edge Device

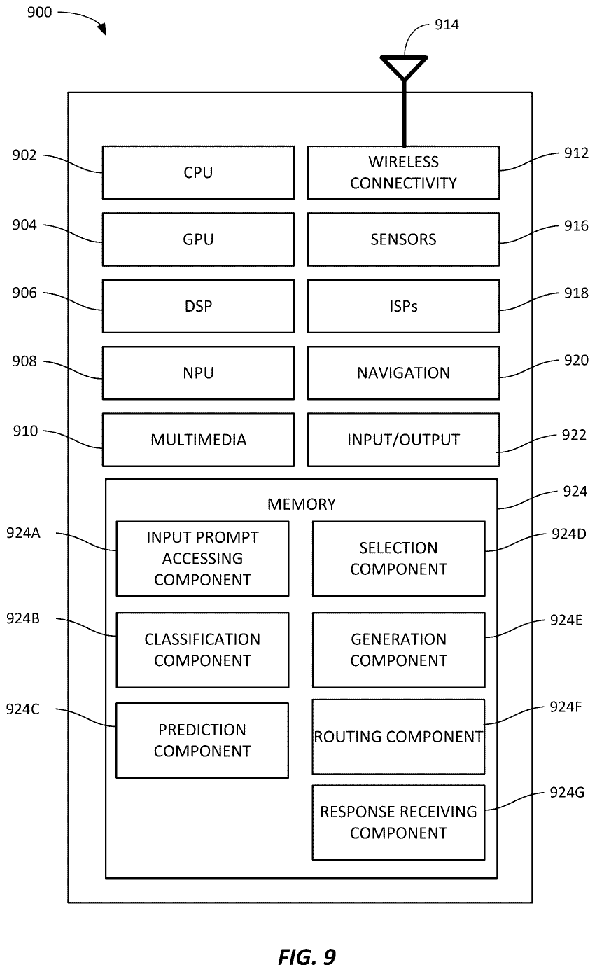

FIG. 9 depicts an example processing system 900 for machine learning by an edge device, such as described herein for example with respect to FIGS. 1-8. The processing system 900 may be (included in) an edge device, such as a mobile device.

The processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., of a memory 924).

The processing system 900 also includes additional processing components tailored to specific functions, such as a graphics processing unit (GPU) 904, a digital signal processor (DSP) 906, a neural processing unit (NPU) 908, and a connectivity component 912.

An NPU, such as the NPU 908, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 908 is a part of one or more of the CPU 902, the GPU 904, and/or the DSP 906. These may be located on a user equipment (UE) in a wireless communication system or another computing device.

In some examples, the connectivity component 912 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 912 may be further coupled to one or more antennas 914.

The processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

The processing system 900 may also include one or more input and/or output devices 922, such as screens, touch-sensitive surfaces (including touch-sensitive displays), physical buttons, speakers, microphones, and the like

In some examples, one or more of the processors of the processing system 900 may be based on an ARM or RISC-V instruction set.

The processing system 900 also includes a memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

In particular, in this example, the memory 924 includes an input prompt accessing component 924A, a classification component 924B, a prediction component 924C, a selection component 924D, a generation component 924E, a routing component 924F, and a response receiving component 924G. The depicted components, and others not depicted, may be configured to perform various aspects of the methods described herein.
Generally, the processing system 900 and/or components thereof may be configured to perform the methods described herein.

### Example Clauses

Implementation details of various aspects of the present disclosure are described in the following numbered clauses:
Clause 1: A method of machine learning by an edge device, the method comprising: accessing an input prompt at the edge device; selecting, based on the input prompt and using a trained router machine learning model executing on the edge device, whether to process the input prompt using a first machine learning model or a second machine learning model, wherein the second machine learning model has a larger size than the first machine learning model; and based on the selection, either: (i) generating a response to the input prompt using the first machine learning model executing on the edge device; or (ii) routing the input prompt to the second machine learning model for generation of the response.
Clause 2: The method of Clause 1, wherein: the first machine learning model comprises a small language model (SLM); and the second machine learning model comprises a large language model (LLM).
Clause 3: The method of Clause 1 or 2, wherein the first machine learning model is an edge machine learning model, and wherein the second machine learning model is a cloud machine learning model and is configured to execute on a device external to the edge device.
Clause 4: The method of any combination of Clauses 1-3, further comprising receiving the response from the second machine learning model in response to the routing the input prompt to the second machine learning model.
Clause 5: The method of any combination of Clauses 1-4, further comprising classifying, using the trained router machine learning model, the input prompt, wherein the selecting, based on the input prompt and using the trained router machine learning model executing on the edge device, is further based on the classification of the input prompt.
Clause 6: The method of Clause 5, wherein the classifying comprises classifying, using the trained router machine learning model, the input prompt to a prompt complexity level.
Clause 7: The method of Clause 6, wherein the selecting comprises selecting the first machine learning model when the prompt complexity level is below a threshold.
Clause 8: The method of Clause 7, wherein the selecting comprises selecting the second machine learning model when the prompt complexity level is at or above the threshold.
Clause 9: The method of any combination of Clauses 6-8, wherein the prompt complexity level is classified from a plurality of prompt complexity levels including at least one of: a first prompt complexity level involving one call to a single function or application programming interface (API) with correct arguments to respond to the input prompt; a second prompt complexity level involving multiple calls to the single function or API with the correct arguments to respond to the input prompt; a third prompt complexity level involving a single call to a correct function or API with the correct arguments to respond to the input prompt; a fourth prompt complexity level involving multiple calls to the correct function or API with the correct arguments to respond to the input prompt; or a fifth prompt complexity level involving: calling a first function or API with the correct arguments; and using the output of the first function or API to call a second function or to respond to the input prompt.
Clause 10: The method of any combination of Clauses 1-9, wherein the trained router machine learning model is trained based on input prompt response quality and input prompt response processing cost capabilities of the first machine learning model and the second machine learning model.
Clause 11: The method of any combination of Clauses 1-10, further comprising predicting, based on the input prompt and using the trained router machine learning model, a response quality of at least one of: the first machine learning model or the second machine learning model.
Clause 12: The method of Clause 11, wherein the selecting comprises selecting a smallest size machine learning model, of a plurality of machine learning models including the first machine learning model and the second machine learning model, having a predicted response quality satisfying a threshold.
Clause 13: The method of Clause 12, wherein the threshold comprises a response quality threshold or a response quality difference threshold.
Clause 14: The method of any combination of Clauses 1-14, wherein the trained router machine learning model comprises a routing neural network model.
Clause 15: The method of any combination of Clauses 1-14, wherein the trained router machine learning model is independent of the first machine learning model executing on the edge device.
Clause 16: The method of any combination of Clauses 1-15, wherein the trained router machine learning model is configured to: obtain a sequence of tokens corresponding to the input prompt; apply a pooling mechanism to the sequence of tokens to generate a pooling representation; output a confidence score based on the pooling representation; and compare the confidence score to a threshold, wherein the selecting, based on the input prompt and using the trained router machine learning model executing on the edge device, is further based on the comparison.
Clause 17: The method of Clause 16, wherein the pooling mechanism comprises at least one of: maximum pooling, average pooling, linear layer pooling, or last token pooling.
Clause 18: The method of any combination of Clauses 1-17, wherein the trained router machine learning model is integrated with the first machine learning model.
Clause 19: The method of Clause 18, further comprising: processing the input prompt by a first one or more layers of the first machine learning model executing on the edge device; and inputting the processed input prompt to the trained router machine learning model, wherein generating the response to the input prompt using the first machine learning model executing on the edge device comprises generating the response to the input prompt using a second one or more layers of the first machine learning model executing on the edge device.
Clause 20: The method of Clause 19, further comprising applying low rank adaptation, in the trained router machine learning model, to the processed input prompt from the first machine learning model executing on the edge device.
Clause 21: A processing system, comprising: at least one memory having executable instructions stored thereon; and one or more processors configured to execute the executable instructions in order to cause the processing system to perform the operations of any of Clauses 1 through 20.
Clause 22: A mobile device comprising the processing system of Clause 21.
Clause 23: A processing system comprising means for performing the operations of any of Clauses 1 through 20.
Clause 24: A non-transitory computer-readable medium having instructions stored thereon which, when executed by one or more processors, perform the operations of any of Clauses 1 through 20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.
As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
at least one memory having executable instructions stored thereon; and
one or more processors configured to execute the executable instructions in order to cause the processing system to:
access an input prompt at an edge device;
select, based on the input prompt and using a trained router machine learning model configured to execute on the edge device, whether to process the input prompt using a first machine learning model or a second machine learning model, wherein the second machine learning model has a larger size than the first machine learning model; and
based on the selection, either:
(i) generate a response to the input prompt using the first machine learning model configured to execute on the edge device; or
(ii) route the input prompt to the second machine learning model for generation of the response.

2. The processing system of claim 1, wherein:
the first machine learning model comprises a small language model (SLM); and
the second machine learning model comprises a large language model (LLM).

3. The processing system of claim 1, wherein the first machine learning model is an edge machine learning model and wherein the second machine learning model is a cloud machine learning model and is configured to execute on a device external to the edge device.

4. The processing system of claim 1, wherein:
the one or more processors are further configured to execute the executable instructions in order to cause the processing system to classify, using the trained router machine learning model, the input prompt; and
to select whether to process the input prompt using the first machine learning model or the second machine learning model, the one or more processors are configured to execute the executable instructions in order to cause the processing system to select, based on the input prompt and on the classification of the input prompt and using the trained router machine learning model, whether to process the input prompt using the first machine learning model or the second machine learning model.

5. The processing system of claim 4, wherein to classify the input prompt, the one or more processors are configured to execute the executable instructions in order to cause the processing system to classify, using the trained router machine learning model, the input prompt with a prompt complexity level.

6. The processing system of claim 5, wherein to select whether to process the input prompt using the first machine learning model or the second machine learning model, the one or more processors are configured to execute the executable instructions in order to cause the processing system to:
select the first machine learning model when the prompt complexity level is at or above a threshold; and
select the second machine learning model when the prompt complexity level is below the threshold.

7. The processing system of claim 5, wherein to classify the input prompt, the one or more processors are configured to execute the executable instructions in order to cause the processing system to classify the input prompt with the prompt complexity level from a plurality of prompt complexity levels including at least one of:
a first prompt complexity level involving one call to a single function or application programming interface (API) with correct arguments to respond to the input prompt;
a second prompt complexity level involving multiple calls to the single function or API with the correct arguments to respond to the input prompt;
a third prompt complexity level involving a single call to a correct function or API with the correct arguments to respond to the input prompt;
a fourth prompt complexity level involving multiple calls to the correct function or API with the correct arguments to respond to the input prompt; or
a fifth prompt complexity level involving:
calling a first function or API with the correct arguments; and
using output of the first function or API to call a second function or to respond to the input prompt.

8. The processing system of claim 1, wherein the trained router machine learning model was trained based on input prompt response quality and input prompt response processing cost capabilities of the first machine learning model and the second machine learning model.

9. The processing system of claim 1, wherein the one or more processors are further configured to execute the executable instructions in order to cause the processing system to predict, based on the input prompt and using the trained router machine learning model, a response quality of at least one of: the first machine learning model or the second machine learning model.

10. The processing system of claim 9, wherein to select whether to process the input prompt using the first machine learning model or the second machine learning model, the one or more processors are configured to execute the executable instructions in order to cause the processing system to select a smallest size machine learning model, of a plurality of machine learning models including the first machine learning model and the second machine learning model, having a predicted response quality satisfying a threshold.

11. The processing system of claim 10, wherein the threshold comprises a response quality threshold or a response quality difference threshold.

12. The processing system of claim 1, wherein the trained router machine learning model is independent of the first machine learning model configured to execute on the edge device.

13. The processing system of claim 1, wherein the trained router machine learning model is configured to:
obtain a sequence of tokens corresponding to the input prompt;
apply a pooling mechanism to the sequence of tokens to generate a pooling representation;
output a confidence score based on the pooling representation; and
compare the confidence score to a threshold, wherein to select whether to process the input prompt using the first machine learning model or the second machine learning model, the one or more processors are configured to execute the executable instructions in order to cause the processing system to select, based on the input prompt and on the comparison and using the trained router machine learning model, whether to process the input prompt using the first machine learning model or the second machine learning model.

14. The processing system of claim 13, wherein the pooling mechanism comprises at least one of: maximum pooling, average pooling, linear layer pooling, or last token pooling.

15. The processing system of claim 1, wherein the trained router machine learning model is integrated with the first machine learning model.

16. The processing system of claim 15, wherein the one or more processors are further configured to execute the executable instructions in order to cause the processing system to:
process the input prompt using a first one or more layers of the first machine learning model; and
input the processed input prompt to the trained router machine learning model, wherein to generate the response to the input prompt, the one or more processors are configured to execute the executable instructions in order to cause the processing system to generate the response to the input prompt using a second one or more layers of the first machine learning model.

17. The processing system of claim 16, wherein the one or more processors are further configured to execute the executable instructions in order to cause the processing system to apply low rank adaptation, in the trained router machine learning model, to the processed input prompt from the first machine learning model.

18. A mobile device comprising the processing system of claim 1.

19. A method of machine learning by an edge device, the method comprising:
accessing an input prompt at the edge device;
selecting, based on the input prompt and using a trained router machine learning model executing on the edge device, whether to process the input prompt using a first machine learning model or a second machine learning model, wherein the second machine learning model has a larger size than the first machine learning model; and
based on the selection, either:
(i) generating a response to the input prompt using the first machine learning model executing on the edge device; or
(ii) routing the input prompt to the second machine learning model for generation of the response.

20. The method of claim 19, further comprising classifying, using the trained router machine learning model, the input prompt, wherein the selecting, based on the input prompt and using the trained router machine learning model executing on the edge device, is further based on the classification of the input prompt.
